(19) United States
(12) Patent Application Publication
(10) Pub. No.: US 2009/0235333 A1
(43) Pub. Date: Sep. 17, 2009

(54) AUTOMATIC ACCESS CONTROL FOR MOBILE DEVICES

(75) Inventors: Thanh Khai Ong, San Diego, CA (US); Sangram U. Tidke, San Diego, CA (US)

Correspondence Address: FOLEY & LARDNER LLP, P.O. BOX 80278, SAN DIEGO, CA, 92138-0278, US

(73) Assignee: Novatel Wireless, Inc.

(21) Appl. No.: 12/049,198

(22) Filed: Mar. 14, 2008

(51) Int. Cl. G06F 21/00

(52) U.S. Cl. 726/4

(57) ABSTRACT

A mobile data device includes a database of identifiers and an authorization module. The identifiers are associated with one or more communication devices in which the mobile data device may be interfaced. The authorization module determines if the identifier of communication device is within the database and facilitates network access to the communication device if it is included.

### FIELD OF THE INVENTION

The present invention relates generally to the field of mobile data device security. In particular, the present invention pertains to accessing a network through a mobile device.

### BACKGROUND OF THE INVENTION

A personal computer (PC) card, PC express card, USB modem, and similar types of mobile data devices are often utilized with laptop computers and similar computing devices in order to obtain networks access. Currently, these types of devices are small, portable and can be easily used through interfacing them with computing devices. However, due to the small size and portability, these mobile devices are also subject to be lost, stolen or otherwise utilized by unauthorized users.

### SUMMARY OF THE INVENTION

One aspect of the present invention provides a mobile device that includes a database of identifiers which correspond to one or more communication devices and an authorization module that facilitates network access to the communication device if the identifier of the communication device is located within the database.

In one embodiment of the invention, the authorization module is adapted to deny network access to the communication device if the communication device identifier is not located within a database of identifiers. In one embodiment, the database of identifiers is a flat file.

In another embodiment, the authorization module is adapted to receive a password from the communication device in order to allow network access through the mobile device. In a further embodiment, the authorization module is adapted to lock the mobile device if a user enters a maximum number predetermined incorrect passwords. In another embodiment, the authorization module is adapted to unlock the mobile device when a user enters an administrative password.

Another embodiment of the present invention allows for the appending of the identifier to the database upon authorization module receiving a password.

In another embodiment, a notification may be sent to an administrator if the mobile device locks.

In one embodiment, the database of identifiers is also utilized to determine the level of network access allowed to the communication device. In one embodiment, the database is written onto the mobile device. In another embodiment, the database is imported onto the mobile device.

Another aspect of the present invention provides a security method for network access that includes determining an identifier associated with a communication device, compares the identifier with a database of identifiers located on the mobile device and facilitates network access to the communication device if the identifier of the communication device is included in the database.

A further aspect of the present invention provides a security method comprising writing a database onto a mobile device, interfacing the mobile device with a communication device, determining if an identifier associated with the communication device is located within the database on the mobile device and allowing network access to the communication device if its associated identifier is located within the database.

A further embodiment provides an authorization module that is adapted to allow network access if the identifier associated with the communication device is not located within the database, but a correct password is received from the communication device.

Yet another aspect of the present invention provides a system that comprises a communication device and a mobile device interfacing the communication device, the mobile device having an authorization module and a database, the authorization module being adapted to allow network access to a communication device if an identifier associated with the communication device is included in the database.

Another aspect of the present invention provides a computer program product on a computer-readable medium, which is configured to determine an identifier associated with a communication device, compare the identifier with a database of identifiers and grant network access to the communication device if the identifier is included within the database of identifiers.

### BRIEF DESCRIPTION OF THE DRAWINGS

FIG. 1A and 1B provide exemplary embodiments of mobile data devices in accordance with the present invention.

FIG. 2 provides a flow diagram of the initial set-up in an embodiment of the present invention.

FIG. 3 provides a flow diagram of the system functionality in an embodiment of the present invention.

### DETAILED DESCRIPTION OF CERTAIN EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

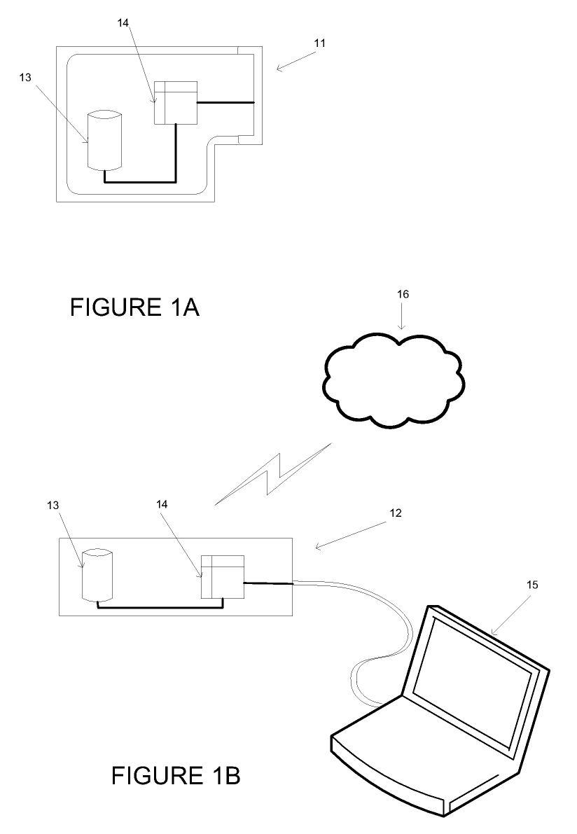

Referring to FIGS. 1A-1B, embodiments of mobile devices are provided in which the present invention may be implemented. A mobile device such as a personal computer (PC) express card 11 (FIG. 1A) or a USB modem 12 (FIG. 1B), may be utilized with a communication device in order to facilitate network 16 access through mobile or wireless data connections, for example. The facilitation of network access may include obtaining, permitting, granting, providing, assisting, allowing or a similar action. The communication device 15 may be a laptop computer, personal computer, PDA, cellular telephone, or similar type device. Each mobile device 11, 12 may contain a database 13 for storing information associated with one or more communication devices.

In one embodiment, the database 13 may include a listing of safe-host devices. A safe-host device indicates a device that is located within the listing on the mobile device 11, 12 and does not need a password entered in order to access the network when interfaced with the mobile device 11, 12. This listing may be contained in a database 13 on the mobile device. The host device may be any of a laptop computer, personal computer, PDA, cellular telephone or similar communication device. This Safe-Host listing may include each communication device's unique identifier, which may be any one of Media Access Control (MAC, MAC-48) address, Ethernet Hardware (EHA) address, Extended Unique Identifier (EUI-48, EUI-64) or other such identifier. The safe-host listing of identifiers may be written into the database 13 in the form of a flat file form in order for the file to be readily available and readable to any type of program. Alternatively, the database 13 may be a relational database including information related to one or more communication devices.

In addition, the mobile device 11, 12 contains an authorization module 14. The module 14 may be utilized to authorize the usage of the mobile device 11, 12 with the communication device when interfaced to the communication device. The mobile device, such as an express card 11 or USB modem 12, may be interfaced with a computing device for an identifier of the communication device to be compared with those listed in the database 13 contained within the mobile device 11, 12. The module 14 interacts with the database 13 located on the mobile device 11, 12 by comparing identifiers of the communication device in which the mobile device 11, 12 is interfaced with the identifiers included in the database 13. In one embodiment, the authorization module 14 may be adapted to allow network 16 access to the communication device, if the identifier of the communication device is included in the database 13 of identifiers. For example, if the identifier of the communication device is listed in the database 13 as a safe-host device, the module 14 determines that the communication device should be allowed access to the network.

Alternatively, in another embodiment when the identifier of the communication device is not included in the database 13 of identifiers, the authorization module 14 provides a prompt on the communication device for the user to enter a password. If the password is matched with a password stored on the mobile device (e.g. on the database 13), the module 14 permits network access. In addition, the identifier may be added to the database 13 of identifiers. If the password is incorrectly entered a predetermined number of times, the authorization module 14 locks the mobile device to prevent unauthorized access. In one embodiment, the user must then interface the mobile device with a communication devices whose identifier is included in the database 13 of identifiers on the mobile device. In another embodiment, the user must enter an administrative password in order to unlock the mobile device. In a further embodiment, an electronic mail (e-mail) or short message service (SMS) notification is sent to the administrator when the mobile device locks.

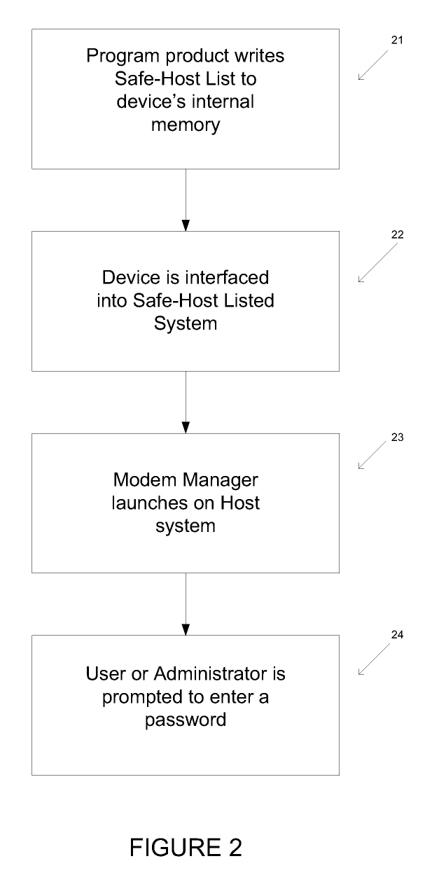

Initially, both the user password and the administrative password must be stored into the mobile device for later usage. FIG. 2 provides a flow diagram of the initial set-up which may be required by the administrator and/or user to program the device. First, the user interfaces the mobile device with a system that is know to be a safe-host system, or an administrative server. A tool, such as a program product or a similar type of product writes the safe-host list of approved systems onto the internal memory located within the module (block 21), or the database of the mobile device. The safe-host list of approved systems is stored in a flat file, which provides a listing of one record per line of data or another type of database.

Once the list is written to the mobile device, the device may remain interfaced with the same safe-host system, or another safe-host listed system, in order to store passwords for future use (block 22). A modem manager or similar type of background service which is auto installed may be launched on the safe-host system (block 23). This service may prompt the administrator and/or user to enter two passwords in order to protect the device (block 24). The user may be requested to enter a user level password as well as an administrative password. Both are stored into the mobile device's internal memory. The information exchange between the modem manager and the mobile device may be completed through secure channeling using an RSA type encryption, for example. Once the set-up is completed, the device may be used by any user that knows at least the user level password of the mobile device.

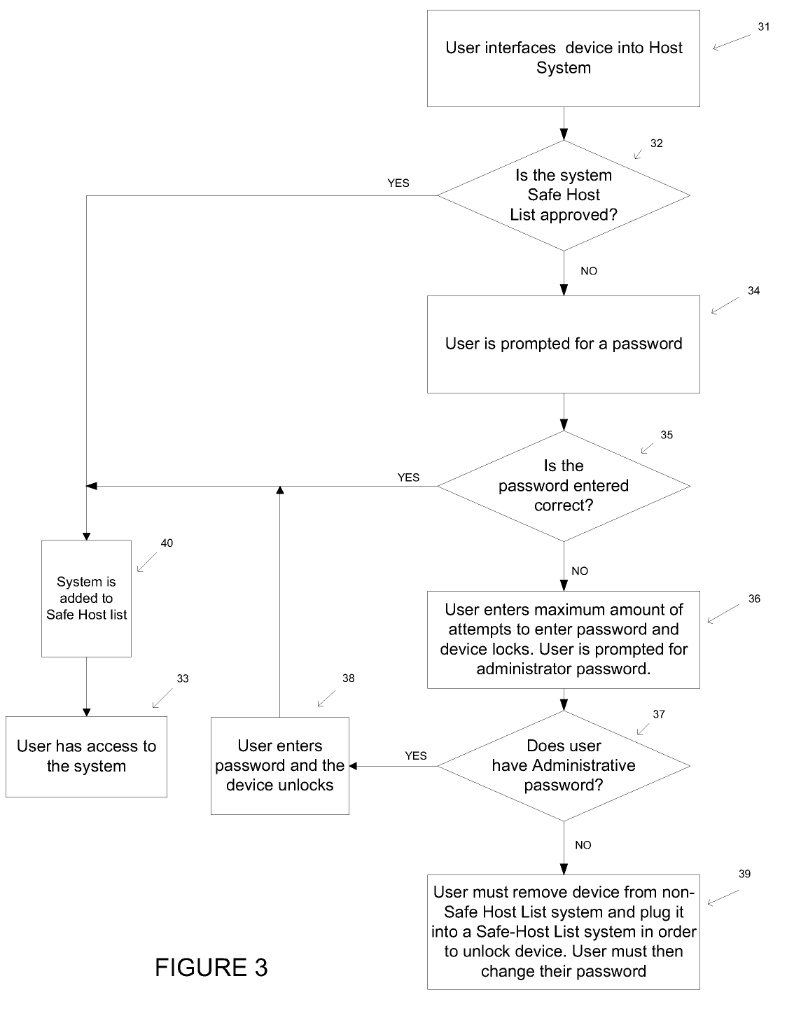

FIG. 3 provides a flow diagram in accordance with an embodiment of the present invention, wherein the mobile device is utilized with a host system. Once the mobile device is interfaced with the host system (block 31), the host system's identifier is compared to the database of identifiers located on the mobile device (block 32). This determines if the host system, or communication device, is authorized access to a network. If an identifier of the host system is located in the database, the user is granted network access (block 33). The mobile device may then provide full access to the network. In a further embodiment, the mobile device may be programmed to provide different levels of network access dependent on the communication device, or host system to which it is interfaced.

In another embodiment, if the host system is not listed within the database on the mobile device, the authorization module located within the mobile device provides a prompt for the user to enter a password (block 34). The password may be one of two types: user or administrator. At least one of these two options is available to the user. Once the user enters a password, the authorization module compares the entry with one or more stored passwords (block 35). Again, this may be accomplished through a secure channel using RSA or a similar type of encryption. If the password entered by the user is matched with a stored password, the user is permitted access through the mobile device to a network (block 33). The host system identifier may be added or appended to the database on the mobile device (block 40). Again, this access may be limited or full dependent on the device's identifier or other factors. In another embodiment, the access type may be determined by the type of password, user or administrative, entered by the user.

However, if the user enters a predetermined number of incorrect passwords, the mobile device locks itself (block 36). When the mobile device locks, the user is prompted to enter an administrative password (block 37). In one embodiment, if the user enters the correct administrative password, the mobile device unlocks itself (block 38). In a further embodiment, the user will then be prompted to begin the process of entering a correct password again (block 34) in order to be granted network access.

In another embodiment, if the user does not have the administrative password to unlock the mobile device, the user must then remove the mobile device and interface it with a system listed on the database of safe-host systems. The mobile device then unlocks and the user may be prompted to store a new password into the mobile device for future use. In another embodiment, the user may need to contact an administrator in order to change and store a new password for device usage.

As well, the mobile device may have capabilities to automatically notify an administrator when the device locks. For example, a notification may be sent through electronic mail (e-mail), short message service (SMS) or a similar type of messaging protocol. Such a notification may also aid in locating the mobile device if the mobile device is lost or stolen, and an unauthorized user attempts to access a network.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A mobile device comprising:
a database of identifiers, each of the identifiers corresponding to one or more communication devices; and
an authorization module adapted to facilitate network access to a communication device if an identifier of the communication device is included in the database.

2. The mobile device of claim 1, wherein the authorization module is further adapted to deny network access to the communication device if the identifier of the communication device is not included in the database.

3. The device of claim 2 wherein the authorization module is adapted to facilitate network access if the identifier associated with the communication device is not located within the database, but a correct password is received from the communication device.

4. The device of claim 3, wherein the authorization module is adapted to append the identifier associated with the communication device to the database.

5. The device of claim 1 wherein the database is a flat file containing a listing of unique identifiers associated with one or more communication devices.

6. The device of claim 1 wherein the authorization module is adapted to receive a password from the communication device in order to provide network access to the device.

7. The device of claim 6 wherein the authorization module is adapted to lock the mobile device when a user enters a predetermined number of incorrect passwords.

8. The device of claim 7 wherein the authorization module is adapted to unlock the mobile device upon receiving an administrative password.

9. The device of claim 7 wherein the authorization module is adapted to send a notification to an administrator.

10. The device of claim 1 wherein the identifiers are media access control addresses.

11. A security method for network access comprising:
determining an identifier associated with a communication device located on a mobile device interfaced with the communication device;
comparing the identifier with a database of identifiers;
facilitating network access to the communication device if the identifier of the communication device is included in the database.

12. The security method of claim 11 wherein the database of identifiers is a flat file.

13. The security method of claim 11 wherein the database of identifiers is utilized to determine the level of network access allowed for the communication device.

14. The method of claim 11 further comprising receiving a password from the communication device in order to facilitate network access to the communication device.

15. The method of claim 11 further comprising writing the database onto the mobile device.

16. The method of claim 11 further comprising importing the database onto the mobile device.

17. A security method comprising:
writing a database onto a mobile device;
interfacing the mobile device with a communication device;
determining if the identifier of communication device is included in a database on the mobile device;
facilitating network access to the communication device if included.

18. The method of claim 17 further comprising an authorization module adapted to facilitate network access to the communication device upon receiving a password from the communication device.

19. A system comprising:
a communication device; and
a mobile device, the mobile device comprising:
an authorization module; and
a database;
wherein the authorization module is adapted to facilitate network access to a communication device if an identifier of the communication device is included in the database.

20. A computer program embodied on a computer-readable medium, the computer program configured to provide a method comprising:
determining an identifier associated with a communication device;
comparing the identifier with a database of identifiers; and
facilitating network access to the communication device if the identifier of the communication device is included in the database.
